(19) United States
(12) Patent Application Publication
(10) Pub. No.: US 2025/0034938 A1
(43) Pub. Date: Jan. 30, 2025

(54) ROLLER TUBE ASSEMBLY HAVING ADJUSTABLE TORQUE

(71) Applicant: Draper, Inc., Spiceland, IN (US)

(72) Inventor: Adam S. Timmins, Noblesville, IN (US)

(21) Appl. No.: 18/779,740

(22) Filed: Jul. 22, 2024

Related U.S. Application Data
(63) Continuation-in-part of application No. 18/226,300, filed on Jul. 26, 2023.

(51) Int. Cl. E06B 9/60; E06B 9/42

(52) U.S. Cl. CPC E06B 9/60; E06B 9/42

(57) ABSTRACT

A roller tube assembly for supporting a window covering between a first window covering bracket and a second window covering bracket may comprise a roller tube adapted to have the window covering rolled onto to raise the window covering and rolled off of to lower the window covering, a torque generator coupled to the roller tube and including a plurality of biasing members positioned within the roller tube, a torque adjustment input operatively coupled to the torque generator and including an operator actuatable input engageable from outside of an envelope of the roller tube, a first mount supporting a first end of the roller tube and adapted to be removably coupled to the first window covering bracket, and a second mount supporting a second end of the roller tube and adapted to be removably coupled to the second window covering bracket. The roller tube, the torque generator, the torque adjustment input, the first mount, and the second mount may be a preassembled unit that is adapted to be coupled to the first window covering bracket and the second window covering bracket.

### CROSS-REFERENCE TO RELATED APPLICATIONS

The present application is a continuation-in-part of U.S. patent application Ser. No. 18/226,300, filed Jul. 26, 2023, docket DRA-0051-01-US, titled ROLLER TUBE ASSEMBLY HAVING ADJUSTABLE TORQUE, the entire disclosure of which is incorporated by reference herein.

### FIELD OF THE DISCLOSURE

The present disclosure relates to window covering systems. More particularly, the present disclosure relates to covering systems having an adjustable torque generator.

### BACKGROUND OF THE DISCLOSURE

Window covering systems, such as roller shades, are movable between open and closed positions and intermediate positions. Window covering systems may be motorized or manually operated. Some manually operated roller shade systems include internal torque generators which maintain the shade material of the roller shade in a desired position. It is desired to be able to adjust the amount of torque provided by the internal torque generator.

### SUMMARY OF THE DISCLOSURE

In an exemplary embodiment of the present disclosure, a roller tube assembly for supporting a window covering between a first window covering bracket and a second window covering bracket is provided. The roller tube assembly comprising: a roller tube adapted to have the window covering rolled onto to raise the window covering and rolled off of to lower the window covering; a torque generator coupled to the roller tube and including a plurality of biasing members positioned within the roller tube; a torque adjustment input operatively coupled to the torque generator and including an operator actuatable input engageable from outside of an envelope of the roller tube; a first mount supporting a first end of the roller tube and adapted to be removably coupled to the first window covering bracket; and a second mount supporting a second end of the roller tube and adapted to be removably coupled to the second window covering bracket. The roller tube, the torque generator, the torque adjustment input, the first mount, and the second mount are a preassembled unit that is adapted to be coupled to the first window covering bracket and the second window covering bracket.

In an example thereof, the torque adjustment input is positioned between a first extreme outer end of the first mount and a second extreme outer end of the second mount.

In another example thereof, the torque adjustment input is positioned proximate the first mount and the first mount includes a plurality of spaced part interfaces which cooperate with corresponding spaced apart interfaces on the first window covering bracket. In a variation thereof, each of the plurality of spaced apart interfaces of the first mount are in a non-intersecting relationship with a longitudinal axis of the roller tube.

In a further example thereof, the torque adjustment input comprising: a base coupled to the first mount; an adjuster including the operator actuatable input rotatable relative to the base; an output operatively coupled to the plurality of biasing members of the torque generator and rotatable relative to the base; and a lock movable by the adjuster between an unlocked position wherein the output is rotatable relative to the base and a locked position wherein the output is held relative to the base.

In a variation thereof, one of the base and the output includes a radial surface engaged by the lock when the lock is in the locked position and the other of the base and the output includes at least one stop engaged by the lock in the unlocked position. In a further variation thereof, the at least one stop engaged by the lock in the locked position to hold a position of the output relative to the base.

In another variation thereof, the adjuster includes a wheel surrounding the longitudinal axis of the roller tube, an outer circumference of the wheel being the operator actuatable input and an actuator carried by the wheel, the actuator engaging the lock to move the lock from the locked position to the unlocked position. In a further variation thereof, the lock includes a torsion spring positioned about the base, the torsion spring having a sprung configuration corresponding to the unlocked position wherein the torsion spring is rotatable relative to the base and an unsprung configuration corresponding to the locked position wherein the torsion spring is held stationary relative to the base.

In yet another variation thereof, the roller tube assembly further comprising a carriage which supports the plurality of biasing members of the torque generator. The output of the torque adjustment input includes an elongated shaft which extends through the carriage and is operatively coupled to the plurality of biasing members of the torque generator within a longitudinal extent of the carriage and a support wheel coupled to the elongated shaft and including at least one stop surface engageable by the lock. In a further variation thereof, the carriage is rotatable with the roller tube relative to the torque adjustment input. In still a further variation thereof, the base includes a radial surface engaged by the lock when the lock is in the locked position and the at least one stop of the support wheel of the output is engaged by the lock in both the unlocked position and the locked position, in the locked position the at least one stop holds a position of the output relative to the base. In still a further variation thereof, the adjuster includes a wheel surrounding the longitudinal axis of the roller tube, an outer circumference of the wheel being the operator actuatable input and an actuator carried by the wheel, the actuator engaging the lock to move the lock from the locked position to the unlocked position. In yet still a further variation thereof, the lock includes a torsion spring positioned about the base, the torsion spring having a sprung configuration corresponding to the unlocked position wherein the torsion spring and the output are rotatable relative to the base and an unsprung configuration corresponding to the locked position wherein the torsion spring and the output are held stationary relative to the base. In still yet a further variation thereof, the roller tube assembly further comprising a travel limiter coupled to the roller tube. The travel limiter including a threaded shaft received in the roller tube, a stop coupled to the threaded shaft, and a traveling stop threadably engaged with the threaded shaft and coupled to the roller tube to rotate with the roller tube. In still yet a further variation thereof, the threaded shaft is coupled to the torque adjustment input and rotatable with the output of the torque adjustment input.

In a further exemplary embodiment of the present disclosure, a torque generator assembly for providing torque to a roller tube of a roller tube assembly as the roller tube assembly is operated between a first position and a second position is provided. The torque generator assembly comprising: an outer shell defined about a central axis and having an open interior; an input interface accessible from a first axial exterior side of the outer shell; an output interface accessible from a second axial exterior side of the outer shell and rotatable with the input interface, the output interface being sized and shaped to mate with the input interface; and a biasing member disposed in the open interior of the outer shell, the biasing member including a first biasing end operatively coupled to input interface and a second biasing end operatively coupled to the outer shell to rotate about the central axis with the outer shell.

In a further exemplary embodiment, a method of installing the roller tube assembly of any of the disclosed roller tube assemblies is provided. The method comprising the steps of: coupling the first mount to the first window covering bracket, the first mount being non-rotatable relative to the first window covering bracket; coupling the second mount to the second window covering bracket; and removing a retainer holding a position of a first portion of the roller tube assembly coupled to a first end of the plurality of biasing members relative to a second portion of the roller tube assembly coupled to a second end of the plurality of biasing members.

In a further exemplary embodiment, a method of building a roller tube assembly is provided, wherein a torque generator includes at least one torque generator cassette structured to provide a torque output, wherein the torque adjustment input and the first mount are part of a preassembled torque adjustment unit, and comprising the steps of: assessing a minimum torque threshold required to counterbalance a torque imparted to the roller tube when a covering of the roller tube is extended in a downward position; identifying a number of torque generator cassettes that provide a total torque output when operating together to exceed the minimum torque threshold; and operatively coupling the number of torque generator cassettes to the preassembled torque adjustment unit.

In an example thereof, the method further comprising the step of adjusting a torque level of the torque generator relative to the roller tube. In a variation thereof, the step of adjusting the torque level of the torque generator relative to the roller tube includes the step of moving the operator actuatable input relative to the roller tube. In another variation thereof, the step of moving the operator actuatable input relative to the roller tube includes the step of rotating the operator actuatable input relative to the roller tube.

### BRIEF DESCRIPTION OF THE DRAWINGS

The above-mentioned and other features and advantages of this disclosure, and the manner of attaining them, will become more apparent and will be better understood by reference to the following description of exemplary embodiments taken in conjunction with the accompanying drawings, wherein:

FIG. 1 illustrates a diagrammatic view of a roller tube assembly of the present disclosure including a torque generator and a torque adjustment input;

FIG. 2A illustrates a perspective view of an exemplary embodiment of roller tube assembly of FIG. 1 coupled to a pair of internal mount brackets;

FIG. 2B illustrates a perspective view of another exemplary embodiment of roller tube assembly of FIG. 1 coupled to a pair of external mounts;

FIG. 2C illustrates a detail view of the exemplary embodiment of a portion of the roller tube assembly and one end bracket of FIG. 2A;

FIG. 2D illustrates a detail view of the exemplary embodiment of a portion of the roller tube assembly and one end bracket of FIG. 2B;

FIG. 3 illustrates a partial exploded perspective view of the roller shade system of FIG. 2A illustrating an exemplary torque generator, an exemplary torque adjustment input, and an exemplary travel limiter along with one of the internal mount brackets;

FIG. 4 illustrates a sectional view of an assembly of the travel limiter, torque generator, and torque adjustment input along lines 4-4 in FIG. 3 coupled to one of the internal mount brackets;

FIG. 5 illustrates a perspective end view of the internal mount bracket with the assembly of the travel limiter, torque generator, and torque adjustment input coupled thereto;

FIG. 6A illustrates a first perspective view of the assembly of the travel limiter, torque generator, and torque adjustment input of FIG. 3;

FIG. 6B illustrates a second perspective view of the assembly of the travel limiter, torque generator, and torque adjustment input of FIG. 6A;

FIG. 7 illustrates an exploded view of the assembly of the travel limiter, torque generator, and torque adjustment input;

FIG. 8 illustrates a sectional view of the assembly of the travel limiter, torque generator, and torque adjustment input along lines 8-8 in FIG. 6A;

FIG. 9 illustrates an exploded perspective view of the torque adjustment input of FIG. 3;

FIG. 10 illustrates a sectional view of the torque adjustment input of FIG. 3 along lines 10-10 of FIG. 6A with the torque adjustment input in a first, hold configuration;

FIG. 11 illustrates the sectional view of FIG. 10 with the torque adjustment input in a second, adjust configuration;

FIG. 12 illustrates an exemplary lower hem bar of the exemplary shade of FIG. 2A and associated adjustment tool;

FIG. 13 illustrates a partial exploded perspective view of a roller shade system having a roller tube, preassembled torque adjustment unit, and a torque generator illustratively including several torque generator cassettes;

FIG. 14 illustrates an assembled roller tube assembly having the preassembled torque adjustment unit and torque generator that includes several torque generator cassettes;

FIG. 15 illustrates a sectional view of an assembly of the roller tube, preassembled torque adjustment unit and torque generator cassette along lines 15-15 of FIG. 14;

FIG. 16 illustrates an exemplary torque generator cassette of the exemplary shade of FIG. 13;

FIG. 17 illustrates a partial exploded perspective view of a torque generator;

FIG. 18 illustrates an exemplary preassembled torque adjustment unit of the exemplary shade of FIG. 13;

FIG. 19 illustrates a sectional view of the preassembled torque adjustment unit of the exemplary shade of FIG. 13 along lines 15-15 of FIG. 14;

FIG. 20 illustrates a partial exploded perspective view of a torque adjustment unit;

FIG. 21 illustrates a partial exploded perspective view of a housing and biasing member of a torque generator cassette;

FIG. 22 illustrates a partial perspective view of the preassembled torque adjustment unit of the exemplary shade of FIG. 13 along lines 23-23 in FIG. 18;

FIG. 23 illustrates a sectional view of the preassembled torque adjustment input of FIG. 18 along lines 23-23 in FIG. 18 with the torque adjustment input in a first, hold configuration; and

FIG. 24 illustrates the sectional view of FIG. 23 with the torque adjustment input in a second, adjust configuration.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

In some instances throughout this disclosure and in the claims, numeric terminology, such as first, second, third, and fourth, is used in reference to various components, inputs, and other items. Such use is not intended to denote an ordering of the components. Rather, numeric terminology is used to assist the reader in identifying the component being referenced and should not be narrowly interpreted as providing a specific order of components.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

The present disclosure is directed to roller tube assemblies for supporting a window covering between a first window covering bracket and a second window covering bracket. Exemplary window coverings include fabrics, pleated blinds, and other suitable materials that may be rolled onto and off of a roller tube. Exemplary roll tube assemblies may comprise a roller tube adapted to have the window covering rolled onto to raise the window covering and rolled off of to lower the window covering, a torque generator coupled to the roller tube and including a plurality of biasing members which may be positioned within the roller tube, a torque adjustment input operatively coupled to the torque generator and including an operator actuatable input engageable from outside of an envelope of the roller tube, a first mount supporting a first end of the roller tube and adapted to be removably coupled to the first window covering bracket, and a second mount supporting a second end of the roller tube and adapted to be removably coupled to the second window covering bracket. In embodiments, the roller tube, the torque generator, the torque adjustment input, the first mount, and the second mount may be a preassembled unit that is adapted to be coupled to the first window covering bracket and the second window covering bracket.

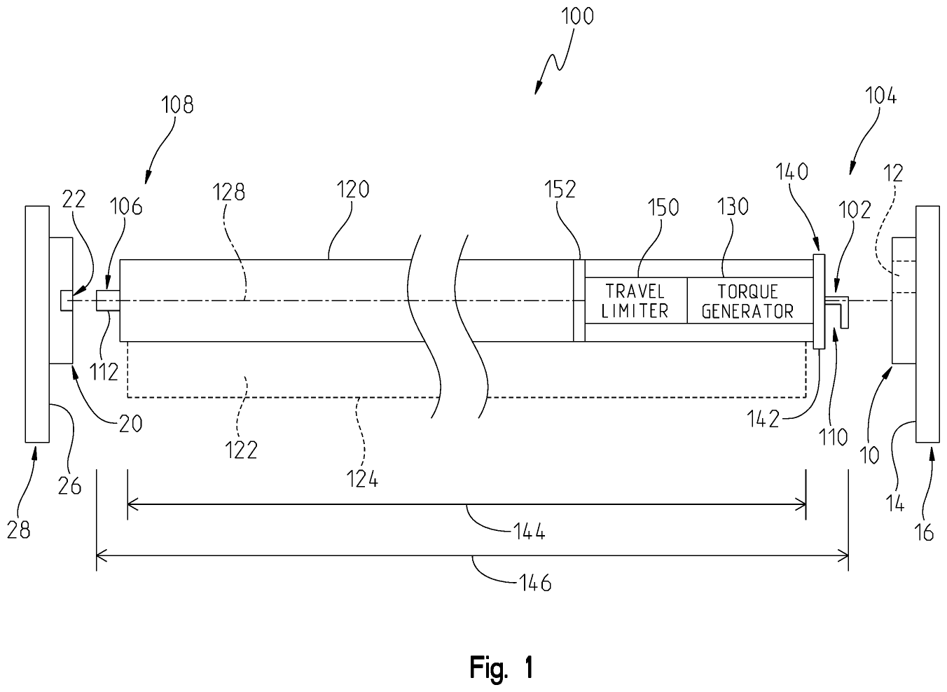

Referring to FIG. 1, an exemplary roller tube assembly 100 is shown. Roller tube assembly 100 includes a first mount 102 on a first end 104 of roller tube assembly 100 and a second mount 106 on a second end 108 of roller tube assembly 100, the second end 108 being opposite the first end 104. First mount 102 includes at least one interface 110 which cooperates with at least one interface 12 of a first window covering bracket 10 that is coupled to a surface 14 of the environment and second mount 106 includes at least one interface 112 which cooperates with at least one interface 22 of a second window covering bracket 20 that is coupled to a surface 26 of the environment. Surfaces 14, 26 may be wall 16, 28 of a window encasement. Further, first window covering bracket 10 and second window covering bracket 20 may be a top mount which mounts to a ceiling or upper wall of a window encasement. Additionally, first window covering bracket 10 and second window covering bracket 20 may be a front mount that attaches to a wall forward of the window. Although not shown, first window covering bracket 10 and second window covering bracket 20 may be covered by a facia.

As illustrated, at least one interface 112 is a shaft that is received in a receiver in second window covering bracket 20 and at least one interface 110 is a hook which is received in a slot in first window covering bracket 10. Other exemplary interfaces include fasteners and threaded apertures, mating shapes, and other suitable shapes for coupling first mount 102 and first end 104 to the respective one of first window covering bracket 10 and second window covering bracket 20. In embodiments, first end 104 is rotatable relative to at least one interface 22 while first mount 102 is held stationary relative to first window covering bracket 10.

Roller tube assembly 100 further includes a roller tube 120 adapted to have a window covering 122 rolled onto to raise the window covering when the roller tube 120 is rotated in a first direction and rolled off of to lower the window covering when roller tube 120 is rotated in a second direction opposite the first direction.

Roller tube assembly 100 additionally includes a torque generator 130 coupled to the roller tube 120. Torque generator 130 is configured to hold lower end 124 of window covering 122 in a desired position when lower end 124 of window covering 122 is lowered, such as with an operator's hand or a tool held by the operator. In embodiments, torque generator 130 provides a counterbalance force to the weight of the hanging portion of window covering 122.

Torque generator 130, in embodiments, includes one or more biasing members which provide the counterbalance force. Exemplary biasing members include compression springs, clock springs, and torsion springs. In embodiments, torque generator 130 includes a plurality of biasing members. The one or more biasing members of torque generator 130 may be positioned within an interior of roller tube 120. In one embodiment of torque generator 130, a plurality of clock springs are positioned along a longitudinal axis 128 of roller tube 120. Torque generator 130 on one end is held stationary with first mount 102 and hence with first window covering bracket 10 when roller tube assembly 100 is assembled to first window covering bracket 10 and on another end is coupled with roller tube 120. As lower end 124 of window covering 122 is lowered the torque generated by torque generator 130 increases and as lower end 124 of window covering 122 is raised the torque generated by torque generator 130 decreases.

Roller tube assembly 100 includes a torque adjustment input 140 which is operatively coupled to torque generator 130. Torque adjustment input 140 includes an operator actuatable input 142 engageable from outside of an envelope 144 of roller tube 120. In embodiments, torque adjustment input 140 is further positioned between a first extreme outer end of first mount 102 and a second extreme outer end of second mount 106, represented by line 146. Torque adjustment input 140 may be adjusted to either add torque to torque generator 130 or remove torque from torque generator 130. An advantage of including torque adjustment input 140, among others, is to allow an adjustment of the torque of torque generator 130 as roller tube assembly 100 ages and the characteristics of the biasing members of torque generator 130 change. As shown in FIG. 1, roller tube 120, at least one interface 110, at least one interface 112, torque generator 130, and torque adjustment input 140 are a preassembled unit that is adapted to be coupled to the first window covering bracket 10 and the second window covering bracket 20.

In embodiments, roller tube assembly 100 further includes a travel limiter 150 which has a first portion held stationary with first mount 102 and a second portion which rotates with roller tube 120. Travel limiter 150 sets a lower limit of lower end 124 of window covering 122 and, optionally, an upper limit of lower end 124 of window covering 122. An advantage, among others of including travel limiter 150 is to protect the biasing members of torque generator 130 from being over sprung. An end of travel limiter 150 is supported by a tube support 152 which engages with an internal profile of roller tube 120.

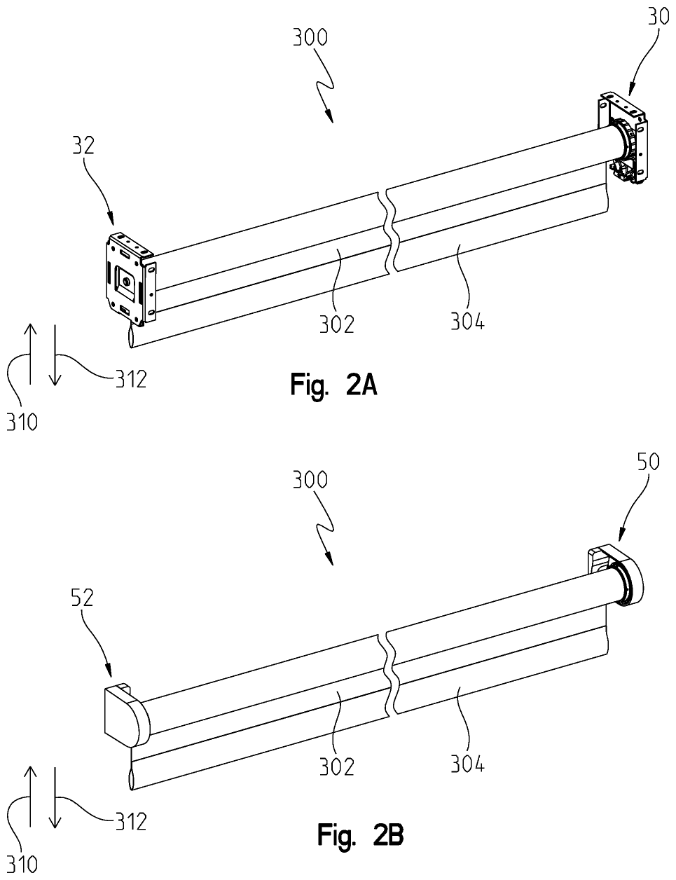

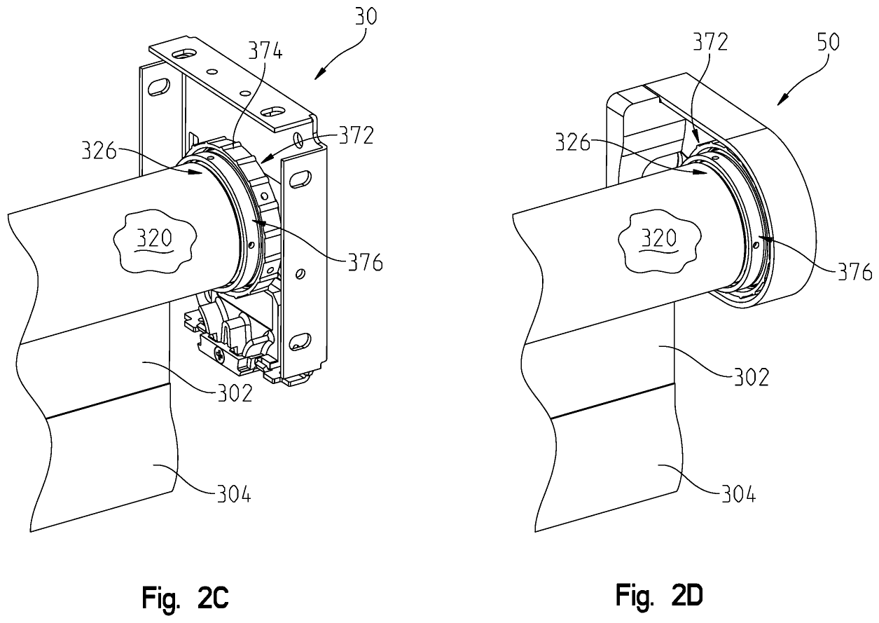

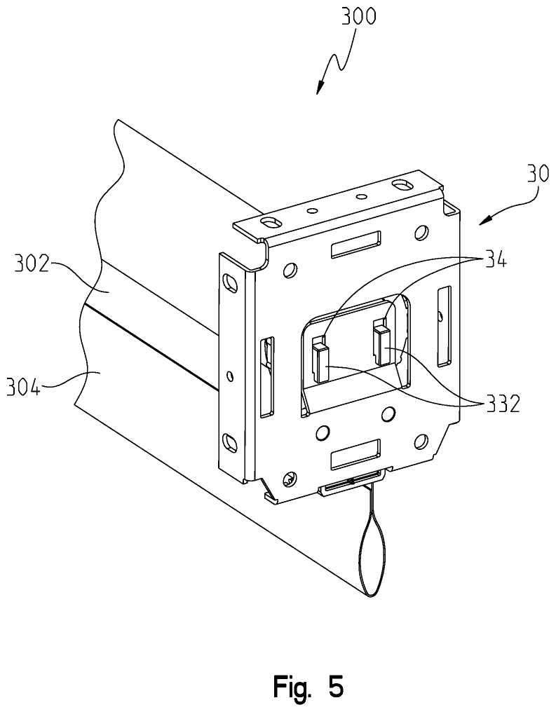

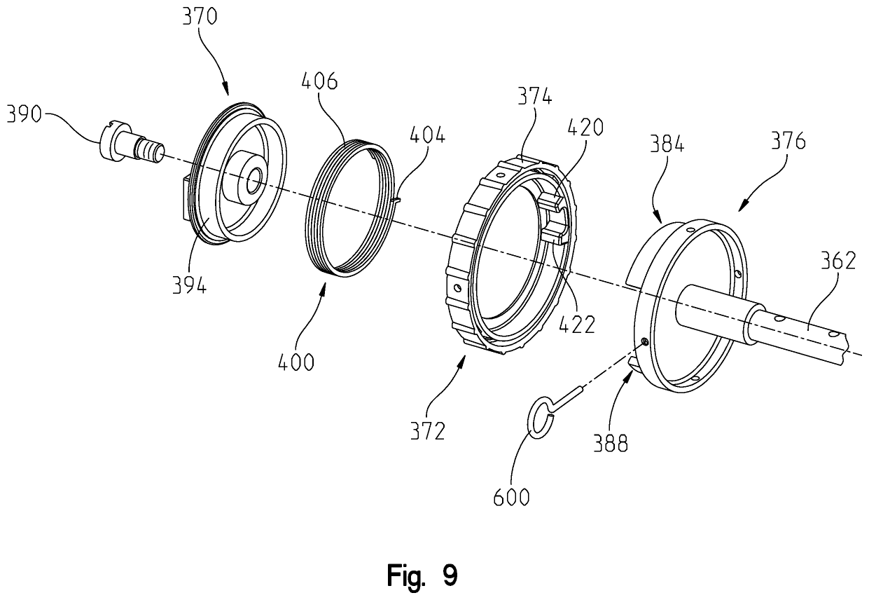

Referring to FIGS. 2A-11, an exemplary roller tube assembly 300 is shown. Roller tube assembly 300 supports a window covering 302 having a lower hem bar 304 (see FIGS. 2A and 2B). Window covering 302 may be raised in direction 310 and lowered in direction 312. Referring to FIG. 2A, roller tube assembly 300 is mounted to a first mount 30 and a second mount 32. Each of first mount 30 and second mount 32 are examples of internal mounts that may be mounted along a top side to a horizontal surface with fasteners (not shown) or mounted along a rear side to a vertically extending wall with fasteners (not shown). In embodiments, a facia may extend from first mount 30 to second mount 32. Referring to FIG. 2B, roller tube assembly 300 is mounted to a first mount 50 and a second mount 52. Each of first mount 50 and second mount 52 are examples of external mounts that may be mounted along a rear side to a vertically extending wall with fasteners (not shown) and which include decorative ends.

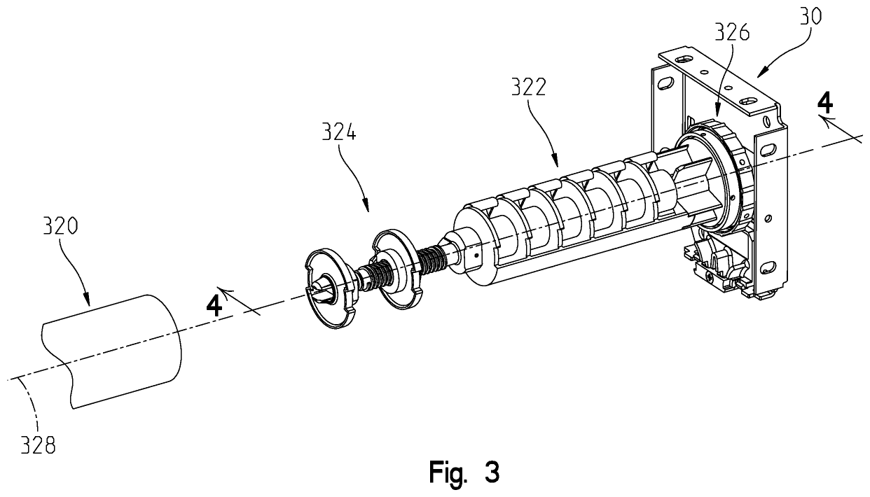

Referring to FIG. 3, roller tube assembly 300 includes a roller tube 320 into an interior of which a torque generator 322 and a travel limiter 324 are inserted. A torque adjustment input 326 extends from a first end of roller tube 320 (see FIG. 2C).

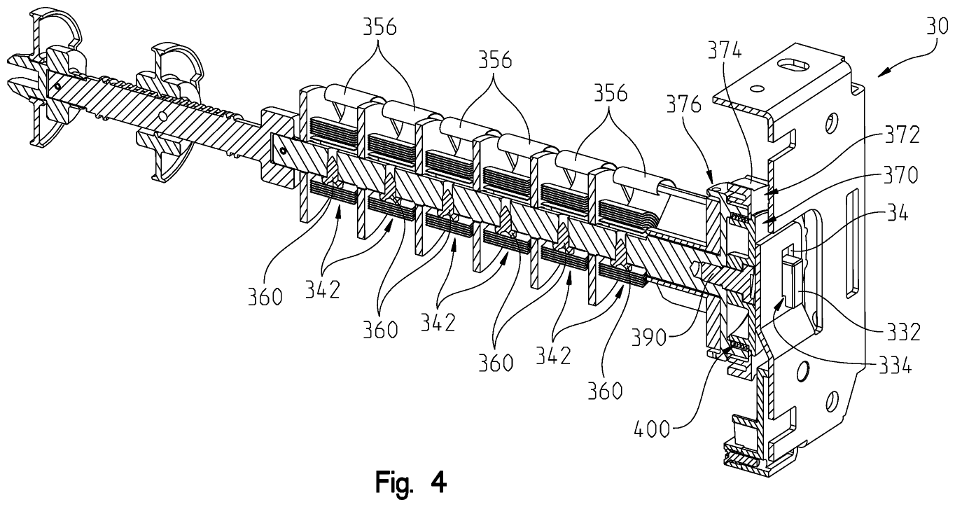

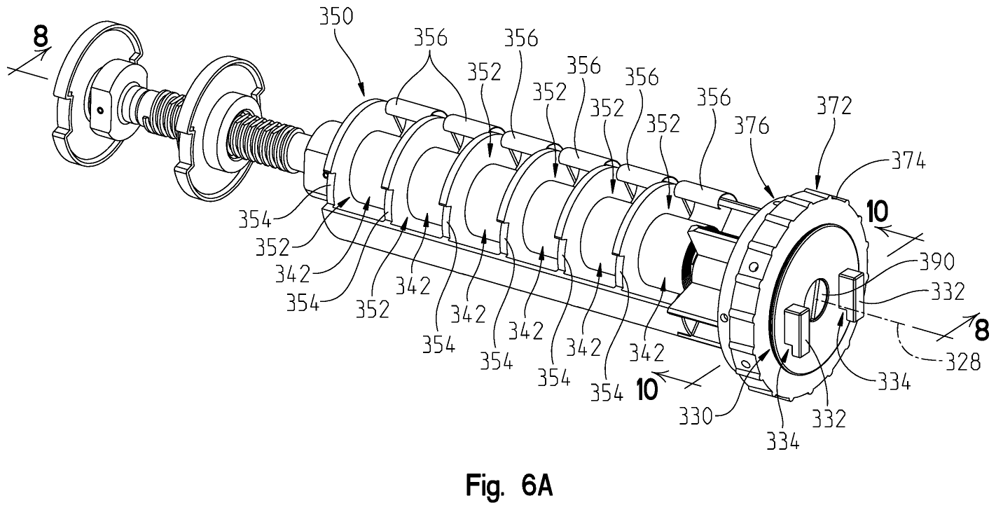

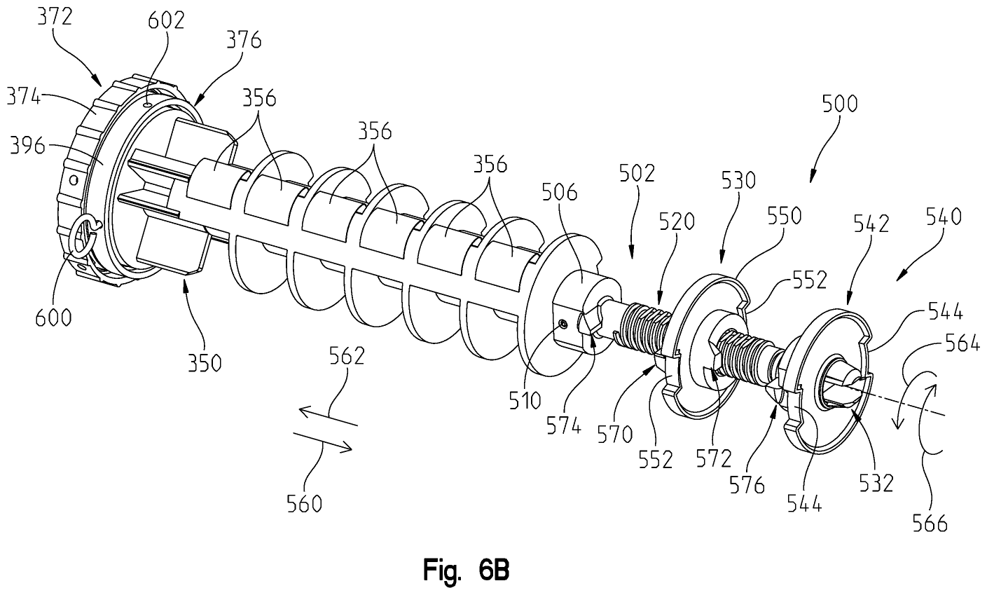

Referring to FIG. 6A, roller tube assembly 300 further includes a first mount 330 having a plurality of spaced apart interfaces 332 which couple to first mount 30 (see FIG. 4). In the illustrated embodiment, each of the spaced apart interfaces 332 are hooks 334 which are received in corresponding slots 34 of first mount 30. As shown in FIG. 6A, each of spaced apart interfaces 332 are in a non-intersecting relationship with a longitudinal axis 328 of roller tube assembly 300. By having multiple interfaces 332 with at least one spaced apart from longitudinal axis 328, first mount 330 is held stationary relative to first mount 30 while roller tube 320 of first mount 330 rotates. An advantage, among others, of having each of spaced apart interfaces 332 equidistant from longitudinal axis 328 is the balancing of the load of roller tube 320 on first mount 330. In embodiments, roller tube assembly 300 includes a second mount, like mount 104, to mount roller tube assembly 300 to second mount 32.

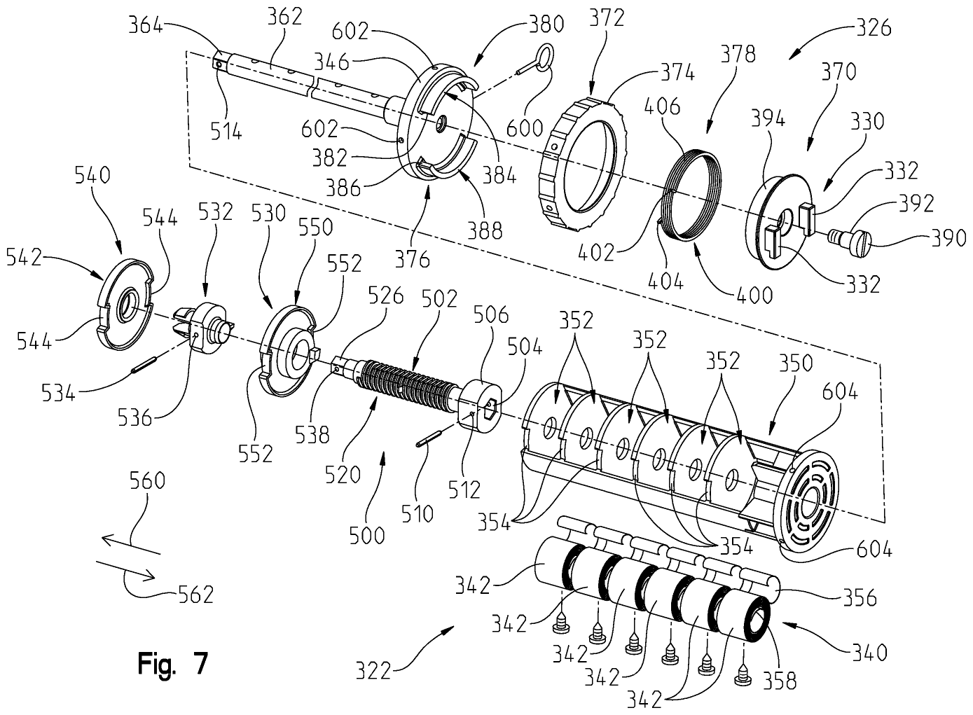

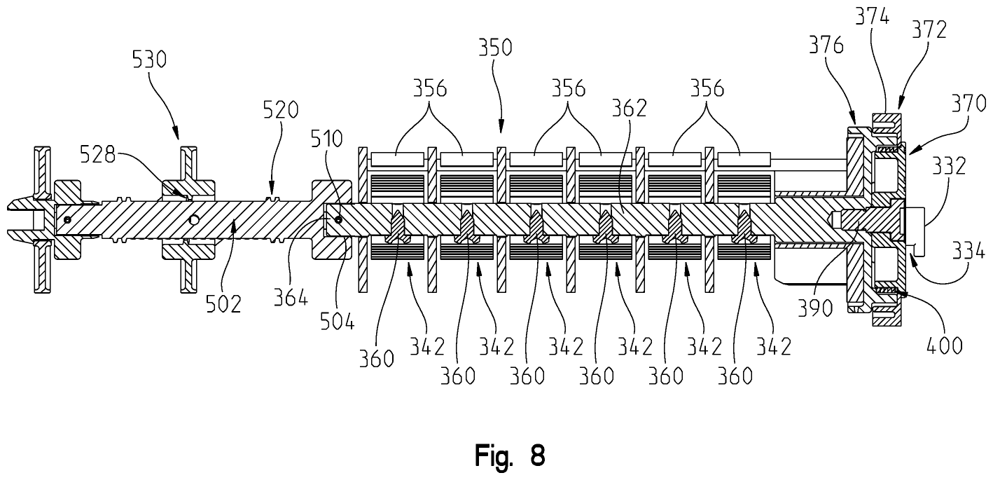

Referring to FIGS. 7 and 8, torque generator 322 includes a plurality of biasing members 340, illustratively clock springs 342. Clock springs 342 are carried by a carriage 350. Carriage includes a separate compartment 352 from each clock spring 342. Further, carriage 350 includes recesses 354 which engage with an internal feature (not shown) of roller tube 320 so that carriage 350 rotates with roller tube 320. A first end 356 (one marked) of clock springs 342 engage carriage 350 (see FIG. 6A). A second end 358 (one marked) of clock springs 342 are secured with fasteners 360 to an elongated shaft 362 (see FIG. 8) As explained herein, elongated shaft 362 is held stationary when roller tube 320 and hence carriage 350 rotate. As roller tube 320 rotates in a first direction to extend window covering 302 and lower hem bar 304, the tension in clock springs 342 increases which increases the torque clock springs 342 exert on roller tube 320 which is needed to maintain a position of lower hem bar 304 once lower hem bar 304 is let go by the operator due to the increased hanging weight of window covering 302 off of roller tube 320. As roller tube 320 rotates in a second direction, opposite the first direction, to retract window covering 302 and raise lower hem bar 304, the tension in clock springs 342 decreases which decreases the torque clock springs 342 exert on roller tube 320 which is allowed due to the decreased hanging weight of window covering 302 off of roller tube 320.

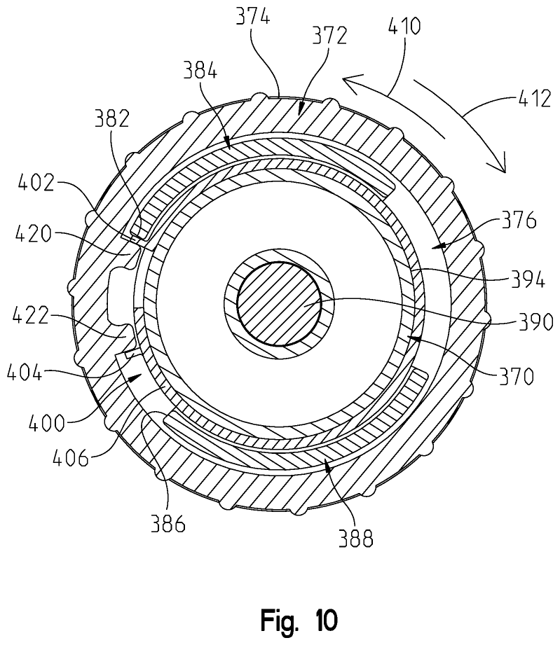

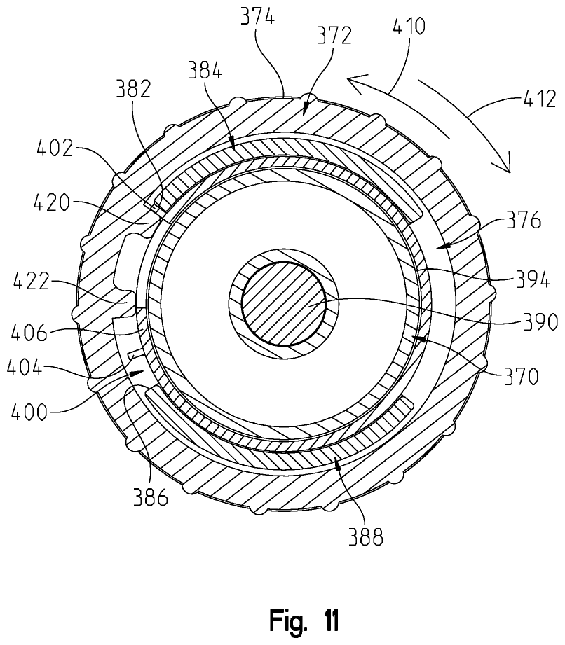

Returning to FIG. 7, torque adjustment input 326 includes a base 370 coupled to first mount 330, an adjuster 372 including an operator actuatable input 374 rotatable relative to base 370, an output 376 which is operatively coupled to biasing members 340 of torque generator 322 and rotatable relative to base 370, and a lock 378 movable by adjuster 372 between an unlocked position (see FIG. 11) wherein output 376 is rotatable relative to base 370 and a locked position (see FIG. 10) wherein output 376 is held relative to base 370. First mount 330 is shown being integral with base 370. In embodiments, first mount 330 is removably coupled to base 370.

Output 376 of torque adjustment input 326 includes elongated shaft 362 which as shown in FIG. 8 extends completely longitudinally through carriage 350. Elongated shaft 362 is operatively coupled to the biasing members 340 of first mount 330 within a longitudinal extent of carriage 350. Output 376 further includes a support wheel 380 coupled to elongated shaft 376. Support wheel 380 includes at least one stop surface, illustratively stop surface 382 of wall 384 and stop surface 386 of wall 388, which as described herein are engageable by lock 378.

Base 370 is coupled to support wheel 380 of output 376 with a fastener 390. In the illustrated embodiment, fastener 390 is a shoulder bolt having a shoulder 392 which allows for 390 and output 376 to rotate relative to base 370 when coupled together. Base 370 further includes a radial surface 394 which is engageable by lock 378. In embodiments, base 370 may include stop surface 382 of wall 384 and stop surface 386 of wall 388 and support wheel 380 may include radial surface 394.

Lock 378 is illustratively a torsion spring 400 having a first end tang 402 and a

second end tang 404. Adjuster 372 is rotatable relative to base 370 and engageable with lock 378 to alter the torque of biasing members 340.

The operation of lock 378 is explained with reference to FIGS. 10 and 11. FIG. 10 illustrates lock 378 in the locked position which is the standard position for torque adjustment input 326. In the locked position windings 406 of torsion spring 400 are in an unsprung configuration contacting radial surface 394 of base 370 and applying pressure to radial surface 394 of base 370 to prevent torsion spring 400 from rotating relative to base 370. Further, stop surface 382 of output 376 is contacting first end tang 402. Without torsion spring 400 being prevented from rotating relative to base 370 due to the interaction between windings 406 of torsion spring 400 and radial surface 394 of base 370, output 376 would continue to rotate torsion spring 400 in direction 410 to relieve tension on biasing members 340.

Adjuster 372 carries an actuator 420 and an actuator 422 which are positioned between first end tang 402 and second end tang 404 of torsion spring 400. Rotating adjuster 372 in either direction 410 or direction 412 results in a separation between first end tang 402 and second end tang 404 increasing which also increases an internal diameter of windings 406 of torsion spring 400 spacing windings 406 from radial surface 394 of base 370 (see FIG. 11). FIG. 11 illustrates lock 378 in the unlocked position wherein windings 406 of torsion spring 400 are in a sprung configuration spaced apart from radial surface 394 of base 370 to permit torsion spring 400 to rotate relative to base 370 as base 370 is further rotated, such as in direction 412 in FIG. 11. As shown in FIG. 11, due to the contact between actuator 420, tang 402, and stop surface 382 of output 376, the rotation of adjuster 372 further in direction 412 due to an operator input on operator actuatable input 374 causes output 376 to rotate relative to base 370 thereby increasing the torque on biasing members 340. When the operator releases operator actuatable input 374 of adjuster 372, adjuster 372 rotates in direction 410 a short distance allowing the separation between first end tang 402 and second end tang 404 to reduce and thereby resulting in locked position windings 406 of torsion spring 400 once again contacting and applying pressure to radial surface 394 of base 370. With torsion spring 400 once again applying pressure to radial surface 394 of base 370, the position of output 376 relative to base 370 is locked and the torque setting of biasing members 340 has been updated. In a similar fashion adjuster 372 may be rotated in direction 410 to separate first end tang 402 and second end tang 404 of torsion spring 400 such that actuator 422 of adjuster 372 can push second end tang 404 into contact with stop surface 386 of wall 388 and cause a rotation of output 376 in direction 410.

Referring to FIG. 7, roller tube assembly 300 further includes a travel limiter 500. Travel limiter 500 includes an elongated shaft 502 having a receiver 504 to receive an end 364 of elongated shaft 362 of output 376. End 364 and receiver 504 are keyed to prevent relative rotation of elongated shaft 502 relative to elongated shaft 362. Elongated shaft 502 is secured to elongated shaft 362 with a pin 510 that is received in holes 512 and 514 of travel limiter 500 and end 364 respectively.

Elongated shaft 502 further includes a threaded section 520 which is threadably engaged with threads 528 (see FIG. 8) of a traveling nut 530. On a second end 526 of elongated shaft 502 a support 532 is coupled thereto with a pin 534 received in holes 536 and 538 in support 532 and second end 526 of elongated shaft 502, respectively. Support 532 is further coupled to a roller tube support 540. Roller tube support 540 includes an outer periphery 542 that generally matches the inner periphery of roller tube 320 and similar to carriage 350 includes recesses 544 that receive internal features of roller tube 320 to key roller tube support 540 to roller tube 320. Roller tube support 540 is rotated relative to support 532 and rotates with roller tube 320 while support 532 remains stationary relative to roller tube 320 due to a fixed connection with base 370 through output 376 and elongated shaft 502.

Traveling nut 530 includes an outer periphery 550 that generally matches the inner periphery of roller tube 320 and similar to roller tube support 540 includes recesses 552 that receive internal features of roller tube 320 to key roller tube support 540 to roller tube 320. Traveling nut 530 rotates with roller tube 320 and as it does moves relative to elongated shaft 502 in one of direction 560 and direction 562 depending on the rotation direction of roller tube 320 due to the engagement between threaded section 520 of elongated shaft 502 and threads 528 of traveling nut 530.

Referring to FIG. 6B, traveling nut 530 includes a first stop 570 facing carriage 350 and a second stop 572 facing roller tube support 540. A head 506 of elongated shaft 502 includes a third stop 574 facing traveling nut 530 and support 532 includes a fourth stop 576 facing traveling nut 530. As traveling nut 530 advances in direction 560 due to a rotation of roller tube 320 in direction 564 a limit of travel and hence a limit of rotation of roller tube 320 occurs when a lower surface of second stop 572 of traveling nut 530 contacts an upper surface of fourth stop 576 of support 532. Similarly, as traveling nut 530 advances in direction 562 due to a rotation of roller tube 320 in direction 566 a limit of travel and hence a limit of rotation of roller tube 320 occurs when an upper surface of first stop 570 of traveling nut 530 contacts a lower surface of third stop 574 of elongated shaft 502.

As shown in FIG. 6B and FIG. 7, a retainer 600 is received in one of a plurality of openings 602 in a wall 396 of output 376 and passes into one of a plurality of recesses 604 in carriage 350. Retainer 600 prevents the rotation of output 376 relative to carriage 350 to maintain tension on biasing members 340. In operation, retainer 600 is removed, but prior to installation retainer 600 is present as shown in FIG. 6B. Further, if roller tube assembly 300 is to be removed from first mount 30 and second mount 32, pin should be reinserted to again lock a rotational position of output 376 relative to carriage 350.

In embodiments, a method of installing roller tube 320 comprises the steps of: coupling the first mount 330 of roller tube 320 to first mount 30, the first mount 330 being non-rotatable relative to first mount 30; coupling the second mount of roller tube assembly 300 to second mount 32; and removing retainer 600 holding a position of a first portion of roller tube assembly 300 coupled to a first end of biasing members 340 (carriage 350) relative to a second portion of roller tube assembly 300 coupled to a second end of biasing members 340 (output 376). In embodiments, the method further comprises the step of adjusting a torque level of the torque generator 322 relative to the roller tube 320. In embodiments, the step of adjusting the torque level of the torque generator 322 relative to the roller tube 320 includes the step of moving the operator actuatable input 374 relative to the roller tube 320. In embodiments, the step of moving the operator actuatable input relative 374 to the roller tube 320 includes the step of rotating the operator actuatable input 374 relative to the roller tube 320.

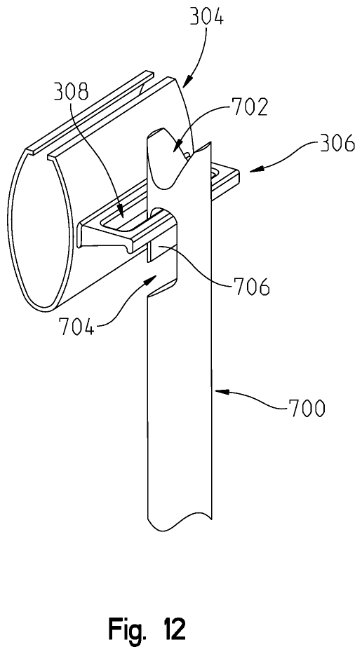

Referring to FIG. 12, in embodiments, lower hem bar 304 includes a handle 306 which may be grasped by an operator to raise or lower hem bar 304 and hence window covering 302. In embodiments, handle 306 is positioned on a window side of lower hem bar 304, on a room side of lower hem bar 304, or two handles 306 with one positioned on a window side of lower hem bar 304 and one on a room side of lower hem bar 304.

In the illustrated embodiment, handle 306 includes an opening 308 which may be engaged by a tool 700 to assist in raising or lowering lower hem bar 304 and hence window covering 302. A top end of tool 700 includes a recess 702 which may engage a lower side of handle 306 to assist in raising lower hem bar 304 by a first portion of recess 702 being received in opening 308. Tool 700 further includes a recess 704 with a hook 706 which may engage an upper side of handle 306 with hook 706 extending through opening 308 of handle 306 to assist in lowering lower hem bar 304.

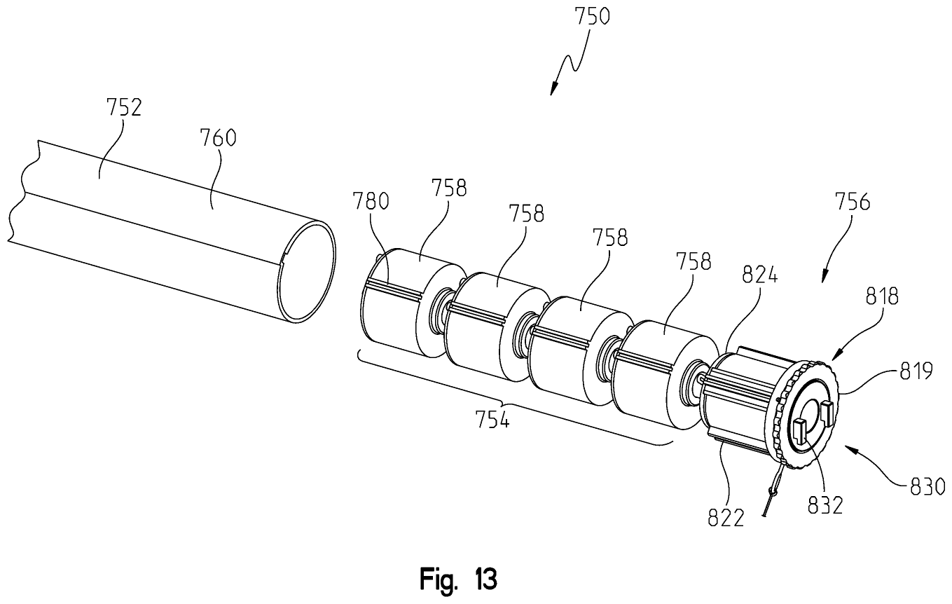

Referring to FIG. 13, another exemplary roller tube assembly 750 is shown. Roller tube assembly 750 includes a roller tube 752 into an interior of which a torque generator 754 and at least part of a preassembled torque adjustment unit 756 are inserted. Although not illustrated, in embodiments, roller tube assembly 750 can include a travel limiter such as that described above with respect to travel limiter 324 (see FIG. 3). In such embodiments, the travel limiter can be located at an axial end of the torque generator 754 opposite the preassembled torque adjustment unit 756 as illustrated in FIG. 3 and coupled to torque generator 754. The torque generator 754 depicted in FIG. 13 includes a plurality of torque generator cassettes 758 that together provide a torque useful to aid in lowering and/or raising window covering 122 which may be wound upon roller tube 752 and/or to maintain a position of lower edge 124 of window covering 122 in the absence of an external force, such as a user tug on window covering 122. Although each torque generator cassette 758 may be configured to provide the same torque as the others, in embodiments, torque generator 754 may include one or more torque generator cassettes 758 that are configured to provide a different torque. In embodiments, each torque generator cassette 758 may be configured to provide a varying torque as window covering 122 is lowered or raised. The collective torque provided by torque generator cassettes 758 may also therefore vary to aid in providing torque to roller tube 752 as roller tube 752 is rotated to a position in which a varying amount of window covering 122 is draped from roller tube 752.

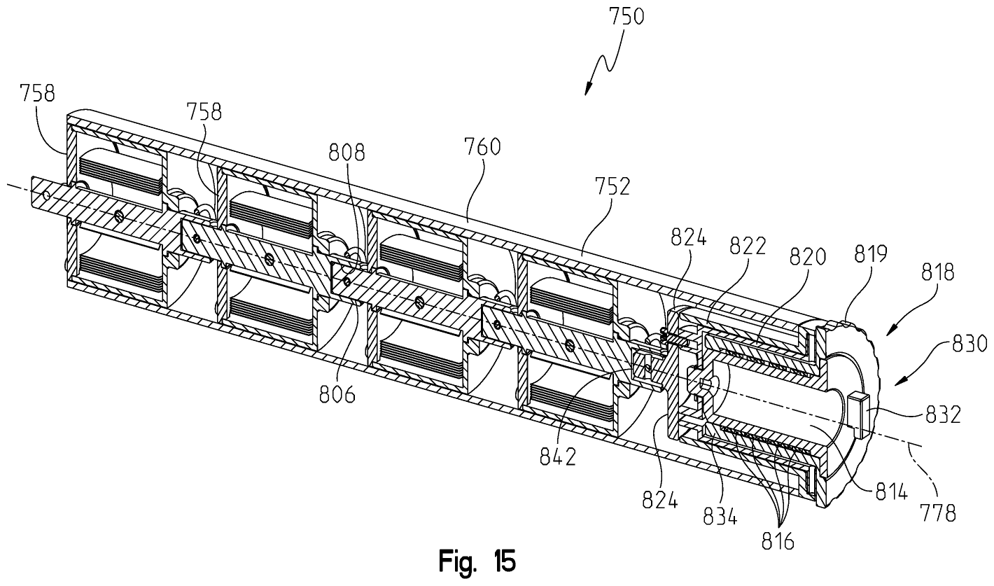

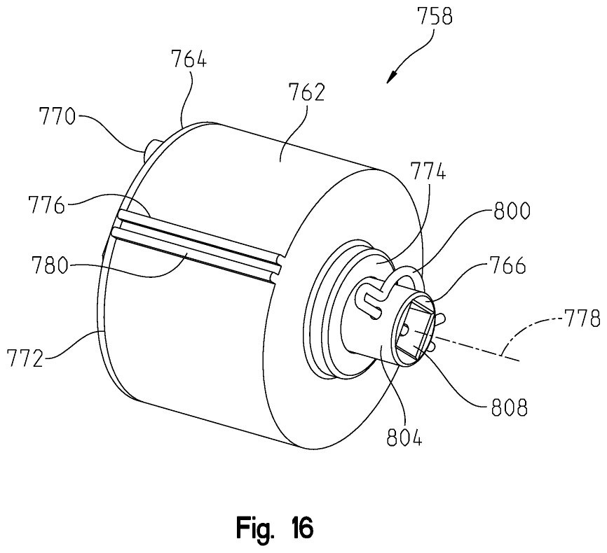

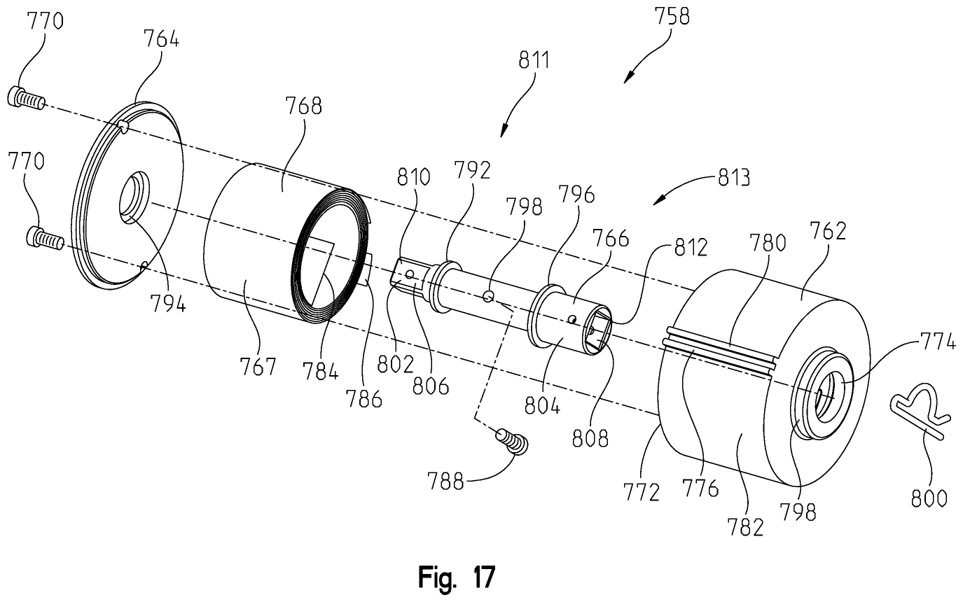

Turning now to FIGS. 16 and 17, and with continuing reference to FIG. 15, torque generator cassette 758 is illustrated which includes a housing 762, a cover 764, a shaft 766, and a biasing member 767 illustratively in the form of a clock spring 768. Housing 762 is configured to surround clock spring 768, and in embodiments housing 762 is configured to enclose clock spring 768, and otherwise provide an enclosure that at least partially protects clock spring 768 from, for example, external debris. In embodiments, housing 762 may include one or more open regions or be solid, but is configured to restrain a size of clock spring 768. Housing 762 may also at least partially protect other components of roller tube assembly 750 and/or personnel from accidental release of a tensioned clock spring 768.

Torque generator cassette 758 includes fasteners 770 useful to secure cover 764 to housing 762. In embodiments, fastener 770 may take a variety of forms, including a threaded fastener, cotter pin, etc. In embodiments, cover 764 is releasably secured to housing 762 such as through the threaded fastener or cotter pin. In alternative embodiments, cover 764 is fixedly secured to housing 762 such as through mechanical fastening (e.g., rivet, nail, etc.), chemical bonding, thermal bonding, etc. Any number of fasteners 770 may be used to secure cover 764 to housing 762. In embodiments, cover 764 and housing 762 include cooperating features to secure cover 764 to housing 762. Exemplary cooperating features include threaded surfaces which may be threadably engaged with each other, snaps, and other suitable cooperating features. In embodiments, the housing 762 and cover 764 may completely enclose clock spring 768, while in other embodiments housing 762 and/or cover 764 may only partially enclose clock spring 768.

Housing 762 is cylindrical in configuration and includes an opening at a first end 772 sized to receive clock spring 768 and an opening at a second end 774 sized to receive shaft 766. The opening at first end 772 is larger in cross sectional area than the opening at second end 774. In embodiments, the opening at second end 774 may have the same cross-sectional area as the opening at second end 774. Housing 762 also includes a tube interface 776 (see FIG. 16) useful to engage an inner surface of roller tube 752 such that a rotation of roller tube 752 when unrolling or rolling of window covering 122 causes sympathetic rotation of cover 764 about a longitudinal axis 778. Tube interface 776 includes a contact surface 780 that extends from an outer surface 782 of housing 762. In embodiments, contact surface 780 is located at the end of a protrusion that extends from outer surface 782. In other embodiments, contact surface 780 may be coincident with the outer surface 782 such that substantially the whole of outer surface 782 of torque generator cassette 758 contacts the inner surface of roller tube 752. In embodiments, contact surface 780 corresponds to the inner wall surfaces of a channel formed by the two illustrated protrusions of tube interface 776, the channel receiving a protruding feature from the inner wall of roller tube 752. Thus, the two protrusions of tube interface 776, in effect, capture the protruding feature from the inner wall of roller tube 752.

To assemble torque generator cassette 758, a first end 784 of clock spring 768 is secured to shaft 766 using a fastener 788. Fastener 788 is received into an aperture 790 formed in shaft 766. In embodiments, fastener 788 may be secured using alternative techniques. For example, in embodiments, fastener 788 may take a variety of forms, including a threaded fastener (received into the aperture 790), cotter pin (e.g., received into an aperture formed in a projection from shaft 766), etc. In embodiments, fastener 788 is releaseably secured to both first end 784 of clock spring 768 and shaft 766 such as through the threaded fastener or cotter pin. In alternative embodiments, fastener 788 is fixedly secured to both first end 784 and shaft 766 such as through mechanical fastening (e.g., rivet, nail, etc.), chemical bonding, thermal bonding, etc. Any number of fasteners 788 may be used to secure first end 784 to shaft 766.

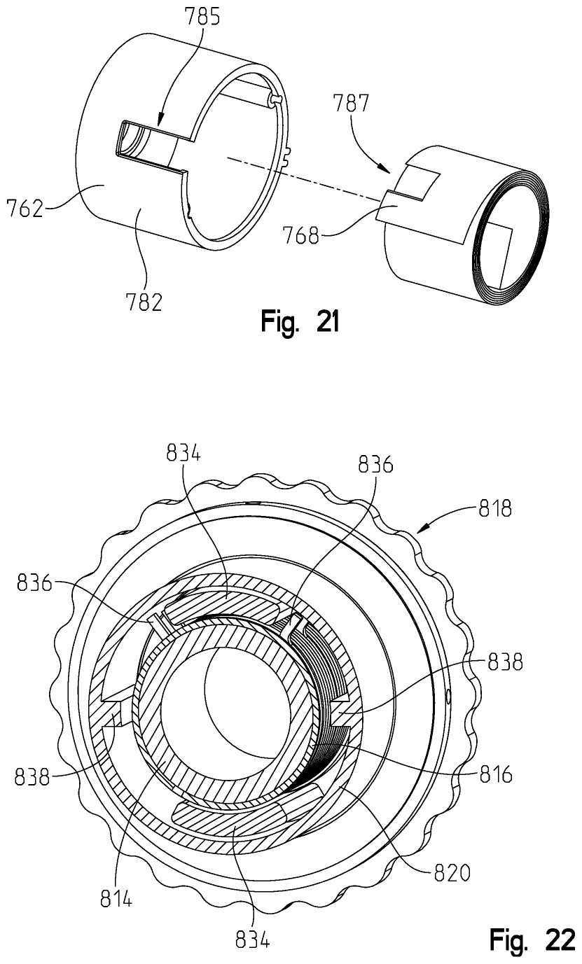

Turning briefly to FIG. 21, and with continuing reference to FIGS. 15-17, a second end 786 of clock spring 768 is secured to housing 762 through a slot connection 785 formed in outer surface 782 of housing 762. Second end 786 includes a notched side 787 that can slide into the slot connection 785 and lock second end 786 of clock spring 768 to housing 762. Clock spring 768 may be axially inserted into an open interior of housing 762 where such axial movement permits the connective interconnection of the notched side 787 of second end 786 and the slot connection 785 in outer surface 782. The connective interaction of the notched side 787 of second end 786 and the slot 785 in outer surface 782 of housing 762 may be prevented from decoupling when cover 764 is attached to housing 762 such that removing clock spring 768 by axial movement away from the open interior is discouraged.

Shaft 766 incudes a first shoulder 792 structured to engage with an abutment surface 794 of cover 764. First shoulder 792 is a raised surface that extends radially beyond a surface of a portion of the shaft 766 that extends through an opening of cover 764. First shoulder 792 is integral to shaft 766. In embodiments, first shoulder 792 is a separate component that is coupled to shaft 766. For example, in embodiments, first shoulder 792 is a clip that is fit around and into a groove formed in shaft 766. The engagement of first shoulder 792 with abutment surface 794 discourages axial movement of shaft 766 such as to capture shaft 766 to housing 762 when torque generator cassette 758 is assembled, while at the same time permitting relative rotational motion to occur between first shoulder 792 and abutment surface 794. In this manner, the engagement of first shoulder 792 with abutment surface 794 is through an abutment-type engagement. The engagement of first shoulder 792 with abutment surface 794 also serves as a plain bearing in the illustrated embodiment when first shoulder 792 contacts abutment surface 794 and there is relative rotation between the two. In other embodiments, the engagement is through any other type of suitable abutment (one or more distributed circumferentially around the interface). In still further embodiments, the abutting engagement may utilize other bearing types, including a ball bearing arrangement having an inner race and outer race. In embodiments, a washer may be interposed between abutment surface 794 and first shoulder 792 to serve as a bearing.

Shaft 766 also includes a second shoulder 796 structured to engage with an abutment surface 798 of housing 762. Abutment surface 798 is a raised surface that extends radially beyond a surface of a portion of shaft 766 that extends through an opening of housing 762. Second shoulder 796 is integral to shaft 766. In embodiments, second shoulder 796 is a separate component that is integrated into shaft 766. For example, in embodiments, second shoulder 796 is a clip that is fit around and into a groove formed in shaft 766. The engagement of second shoulder 796 with abutment surface 798 discourages axial movement of shaft 766 such as to capture shaft 766 to housing 762 when torque generator cassette 758 is assembled, while at the same time permitting relative rotational motion to occur between second shoulder 796 and abutment surface 798. In this manner, the engagement of second shoulder 796 with abutment surface 798 is through an abutment-type engagement. The engagement of second shoulder 796 with abutment surface 798 is via a plain bearing in the illustrated embodiment when second shoulder 796 contacts abutment surface 798 and there is relative motion between the two. In other embodiments, the engagement is through any other type of suitable abutment (e.g., one or more abutments distributed circumferentially around the interface). In still further embodiments, the abutting engagement may utilize other bearing types, including a ball bearing arrangement having an inner race and outer race. In embodiments, a washer may be interposed between abutment surface 798 and second shoulder 796 to serve as a bearing.

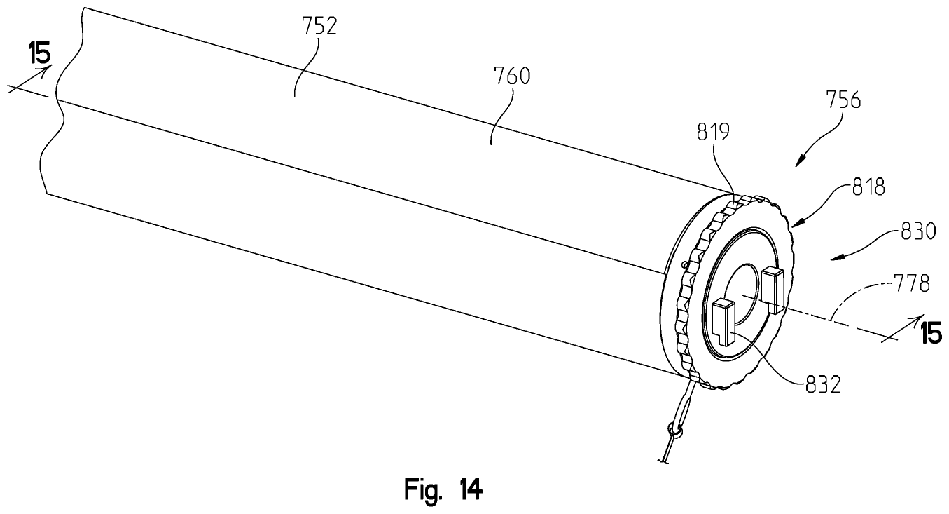

A fastener 800 is used to secure ends of shafts 766 with a corresponding end of an adjacent shaft 766. For example, shaft 766 includes a first end 802 and a second end 804 that may be secured to a corresponding second end 804 and first end 802, respectively, of a different torque generator cassette 758. First end 802 is in the form of a plug, and the second end 804 is in the form of a socket. In embodiments, first end 802 may take other forms useful to engage with second end 804, and vice versa, instead of a plug and socket connection. First end 802 includes a coupling surface 806 that is coupled to a coupling surface 808 of the second end 804 of a neighboring shaft 766. In embodiments, the coupling surfaces 806 and 808 may be affixed to each other through any variety of one or more approaches, including mechanical fasteners, chemical bonding, etc, or combinations thereof. Coupling interface 811 (FIG. 17) on an end of shaft 766 includes a coupling surface 806 and pilot feature 810 illustrated FIGS. 14 and 16-17. The coupling interface 811 is useful to engage and become coupled to a neighboring shaft 766. The pilot feature 810 is useful to guide the engagement of coupling surface 806 of one torque generator cassette 758 with second end 804 of a neighboring torque generator cassette 758. Similarly, coupling interface 813 (FIG. 17) on another end of shaft 766 includes a coupling surface 808 and pilot feature 812 illustrated FIGS. 14 and 16-17. The coupling interface 813 is useful to engage and become coupled with either of a neighboring shaft 766 or the preassembled torque adjustment unit 756. The pilot feature 812 is useful to guide the engagement of the coupling surface 808 of one torque generator cassette 758 with the coupling surface 806 of a neighboring torque generator cassette 758. Pilot feature 810 is complementary with pilot feature 812 in such a manner that the engagement of coupling surface 806 with coupling surface 808 results in a mechanical lock of sorts that discourages rotation of one torque generator cassette 758 relative to another torque generator cassette 758. In embodiments, pilot feature 810 and pilot feature 812 is a splined connection. In embodiments, the coupling interface 811 and/or coupling interface 813 may not include a pilot feature 810 and/or pilot feature 812. For example, in embodiments, the coupling interface 811 can be joined to coupling interface 813 through a contact configuration (e.g., overlapping surface, butt joint, etc.) in which the coupling surface 806 and coupling surface 808 may be placed in contact with one another and affixed through suitable fastening and/or bonding techniques. The coupling interface 811 and/or coupling interface 813 may be affixed to each other through any variety of one or more approaches, including mechanical fasteners, chemical bonding, etc., or combinations thereof. One or more features of first end 802 (e.g., coupling surface 806 and/or pilot surface 808) is an input interface useful to engage with an output interface of second end 804 (e.g., coupling surface 808 and/or pilot feature 812).

When first end 802 of one torque generator cassette 758 is engaged with second end 804 of another torque generator cassette 758, fastener 800 is used to secure the engagement so as to discourage axial movement of one torque generator cassette 758 relative to another torque generator cassette 758. Fastener 800 is inserted through separate apertures on each of first end 802 and second end 804 to mechanically lock shaft 766 of one torque generator cassette 758 with shaft 766 of an adjacent torque generator cassette 758. Fastener 800 is a cotter pin in the illustrated embodiments. In embodiments, fastener 800 may take on the form of other fasteners such as a threaded screw, a bolt, and other suitable fasteners. In further embodiments, a permanent mechanical connection, such as with a rivet may be used. In still further embodiments, of the connection may be through a chemical bonding agent such as, but not limited to, glue.

An advantage, among others, of torque generator cassette 758 is that it may be handled as an integrated unit in inventory, assembly, and/or repair operations. Given the nature of integration by which the component parts of torque generator cassettes 758 are secured to each other as described herein, torque generator cassette 758 may be pre-packaged and ready for integration into the roller tube 752, reducing the number of parts required at that stage of assembly. Torque generator cassette 758 may also be readily handled as a single integrated unit. For example, torque generator cassette 758 can have a stock keeping unit (SKU) assigned to it and placed on a shelf, in a bin, etc., ready for use in assembly and/or repair. Faster repairs are also possible given the reduced complexity permitted by the integrated unit. The integrated and modular construction of torque generator cassettes 758 thus permits ease of assembly for manufacturing, ease of inventory management, and ease of replacement when repairs are needed for any given roller tube assembly 750.

Still further to the above, torque generator cassette 758 may be shipped in an unwound condition, and then wound subsequent to installing in roller tube 752 for a given application of torque generator cassette 758. For example, setting torque of torque generator 754 at the fully extended position of the window covering may depend on the type of material used in the window covering. An assembly operation of the torque generator cassette 758 may occur in an offsite location without need to energize the biasing element 768. When the torque generator cassette 758 is received at an integration location (such as a factory configured for final assembly), torque generator cassette 758 may be torqued based on the type of fabric used for a given customer. The torque required to balance window covering 122 may be determined by calculating the weight of the material of window covering 122 at the fully extended position and multiplying by a torque radius. For example, the torque may be found by multiplying the density of the fabric by the volume of fabric at the fully extended position, adding a weight of the hem to the weight of the material, and then multiplying by a torque radius which may include the radius of roller tube 752 plus any thickness of fabric remaining on roller tube 752 when in the fully extended position.

Roller tube assembly 750 may be constructed to include any number of torque generator cassettes 758 depending on the needs of the application. For example, when window covering 122 includes a dense fabric that is long, greater number of torque generator cassettes 758 may be used. This is in contrast to embodiments in which the window covering 122 includes a lower density fabric that is relatively short. During assembly of roller tube assembly 750, the number of torque generator cassettes 758 may be determined and/or the composition of different size torque generator cassettes 758 (e.g., different clock springs for different torque generator cassettes 758) may be determined. Faster design and assembly times are therefore achievable with the modular nature of torque generator cassette 758.

As will be appreciated, shaft 766 of any given torque generator cassette 758 may be deemed a shaft segment, the aggregate of which when coupled together form a shaft for the entirety of torque generator cassette 758. If an embodiment requires a single torque generator cassette 758, shaft 766 serves as both a shaft segment and as a shaft for torque generator 754.

The engagement of shaft 766 with housing 762, via engagement of first shoulder 792 with abutment surface 794, and second shoulder 796 with abutment surface 798, permits relative rotational motion between shaft 766 and housing 762. Since clock spring 768 is coupled at first end 784 with shaft 766 and is coupled at second end 786 with housing 762, relative motion of shaft 766 to housing 762 causes clock spring 768 to wind onto shaft 766 in one direction and unwind from shaft 766 in an opposite direction. Relative motion between housing 762 and shaft 766 occurs either when roller tube 752 is rotated when changing a configuration of window covering 122 (e.g., lowering or raising window covering 122), or occurs when the preassembled torque adjustment unit 756 is used to change the amount of preset torque generated from torque generator 754 (e.g., changing an initial preset position of clock spring 768), described further below. The level of preset torque relates to the degree to which clock spring 768 is wound around shaft 766 (or correspondingly, unwound from shaft 766). An advantage of changing relative position of housing 762 to shaft 766 via preassembled torque adjustment unit 756 is the ability to adjust the tension generated by clock spring 768 when it is wound around shaft 766 (or correspondingly, adjust the tension when clock spring 768 is unwound from shaft 766) to vary the torque and thus provide a varying amount of preset torque to balance roller tube 752 as window covering 122 is rolled or unrolled.

It will be appreciated that, in embodiments, biasing member 767 may take on other forms. For example, in embodiments, biasing member 767 is one or more torsion springs and/or one or more coil springs.

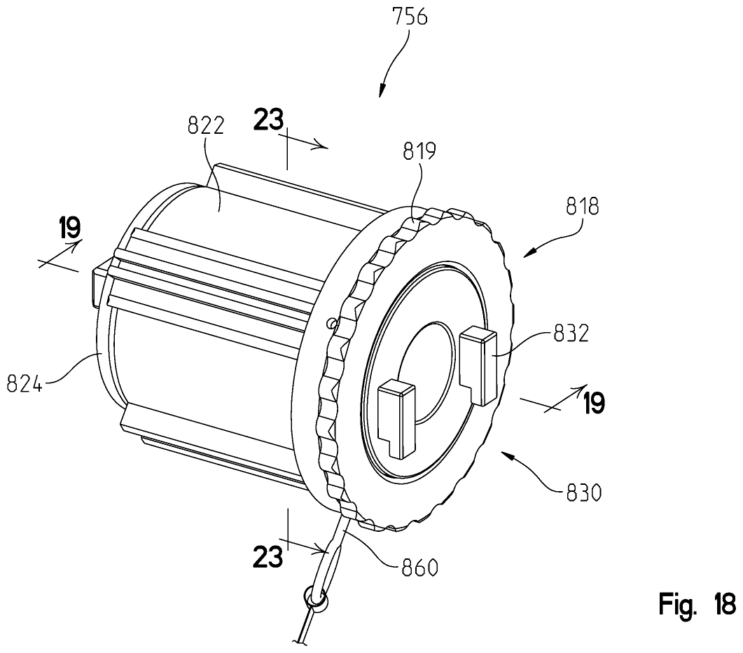

Turning now to FIGS. 18-20, and with continuing reference to FIGS. 13-15, preassembled torque adjustment unit 756 is illustrated which includes a base 814, a lock 816, an input 818 which includes an adjuster 819, an output 820, a roller tube interface 822, and a closeout coupler 824. An inner surface of the open interior of roller tube 752 is configured to engage a contact surface 822 of the roller tube interface 822. Engagement of the roller tube 752 with the roller tube interface 822 is through a friction fit which permits the roller tube interface 822 to rotate with the roller tube 752. In embodiments, the roller tube 752 is engaged with the roller tube interface 822 through other techniques (e.g., chemical bonding, fasteners, etc.) to also permit the roller tube interface 822 to rotate with the roller tube 752. In the embodiment depicted in FIGS. 18-20, the roller tube interface 822 is axially captured by the closeout coupler 824 and the output 820 but is otherwise free to rotate relative to the closeout coupler 824 and output 820. A bearing 828 is located between an end of the roller tube interface 822 and the output 820 which provides a relatively low friction surface should the end of the roller tube interface 822 contact the output 820. In embodiments, the bearing 828 may not be present if a rubbing interface between the end of the roller tube interface 822 and output 820 is low enough.

The base 814 includes a first mount 830 having at least one first interface 832 which cooperates with at least one interface of a first window covering bracket that is coupled to a surface of the environment (e.g., as recited above with respect to FIG. 1). The first mount 830 is, therefore, static, while other components of the roller tube assembly 750 can be rotatable. For example, the roller tube interface 822 and roller tube 752 are rotatable, as are the output 820 and input 818. The output 820 is connected with the closeout coupler 824 via fasteners 840. In embodiments, fewer or greater number of fasteners may be used than those depicted in the figures herein. The fasteners 840 are a threaded fastener in the illustrative embodiment. In other embodiments, the fasteners 840 may be other fastener types including a threaded screw, a bolt, and other suitable fasteners. In further embodiments, a permanent mechanical connection, such as with a rivet may be used. In still further embodiments, of the connection may be through a chemical bonding agent such as, but not limited to, glue. The fasteners 840 is received through apertures formed in the closeout coupler 824 and output 820.

Closeout coupler 824 includes a coupler end 842 having a coupling surface 844 useful to engage with second end 804 of shaft 766 of the torque generator 754. A coupling interface of the closeout coupler 824 includes the coupling surface 844 and a pilot feature 846 useful to guide the engagement of coupler end 842 of closeout coupler 824 with second end 804 of shaft 766. Pilot feature 846 of the illustrated embodiments is complementary with pilot feature 812 of second end 804 in such a manner that the engagement of coupling surface 844 with coupling surface 808 results in a mechanical lock of sorts that discourages rotation of closeout coupler 824 relative to shaft 766. In embodiments, pilot feature 812 and pilot surface 846 is a splined connection. Another fastener 800 can be used to secure closeout coupler 824 to second end 804 of torque generator 754. In embodiments, the coupling interface of the closeout coupler 824 and/or coupling interface 813 may not include a pilot feature 846 and/or pilot feature 812. For example, in embodiments, the coupling interface of the closeout coupler 824 can be joined to coupling interface 813 through a contact configuration (e.g., overlapping surface, butt joint, etc.) in which the coupling surface 844 and coupling surface 808 can be placed in contact with one another and affixed through suitable fastening and/or bonding techniques. The coupling interface of the closeout coupler 824 and/or coupling interface 813 may be affixed to each other through any variety of one or more approaches, including mechanical fasteners, chemical bonding, etc., or combinations thereof

When adjustment is desired of the pre-set torque provided by one or more of torque generator cassettes 758, a user may manipulate adjuster 819 which, when rotated, engages lock 816 to unlock input 818 from base 814, allowing adjuster 819 to continue rotating. As illustrated, lock 816 includes several torsion springs. In embodiments, fewer or greater number of torsion springs may be used. Further, in embodiments, lock 816 may take on other forms that provide for locking input 818 to base 814 so as to prevent rotation of output 820 relative to base 814 when locked, or allow rotation of the output 820 relative to base 814 when unlocked, as will be described further below. Input 818 includes an engagement member 834 that is configured to engage a lock member 836 of the lock 816 which, in the illustrated embodiment, is a tang of the torsion spring. Engagement member 834, upon contact with and displacement of lock member 836, causes lock 816 to be in an unlocked condition from base 814.

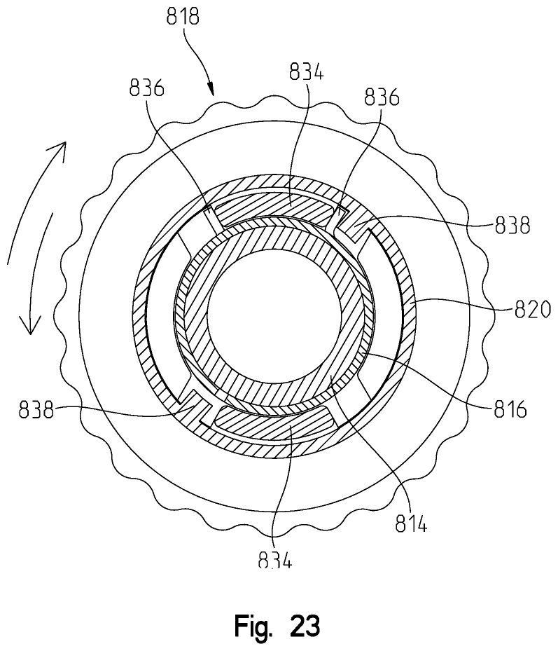

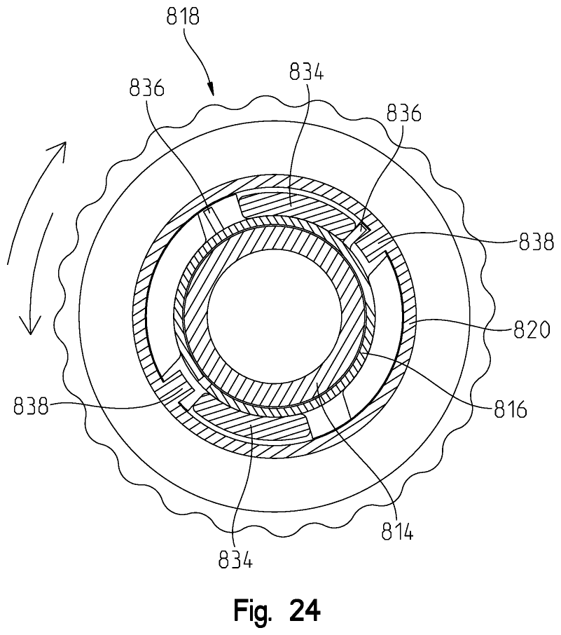

As shown in FIGS. 22-24, when in a locked condition (FIG. 23), the lock 816 effectively discourages substantial movement of the output 820 and subsequent movement of the torque generator cassettes 758. When engagement member 834 is not forced into contact with lock member 836 via movement of input 818, lock 816 grips base 814 and discourages, movement of input 818 and output 820 relative to base 814 by limiting a rotational position of input 818. This, in turn, discourages movement of closeout coupler 824 and subsequent movement of shaft 766 of torque generator cassettes 758. Engagement member 834 of input 818 is also configured to couple an engagement surface 838 of output 820. Engagement of the engagement member 834 with the engagement surface 838 of output 820 causes sympathetic movement of output 820 upon rotation of input 818. Thus, an operator may rotate adjuster 819 which in turn causes input 818 to unlock lock 816 to create an unlocked condition (FIG. 24). Further rotation of adjuster 819 causes input 818 to rotate output 820 which in turn rotates shaft 766 of torque generator 754 to increase or decrease (depending on the direction of rotation) the torque of clock springs 768 on roller tube 752.

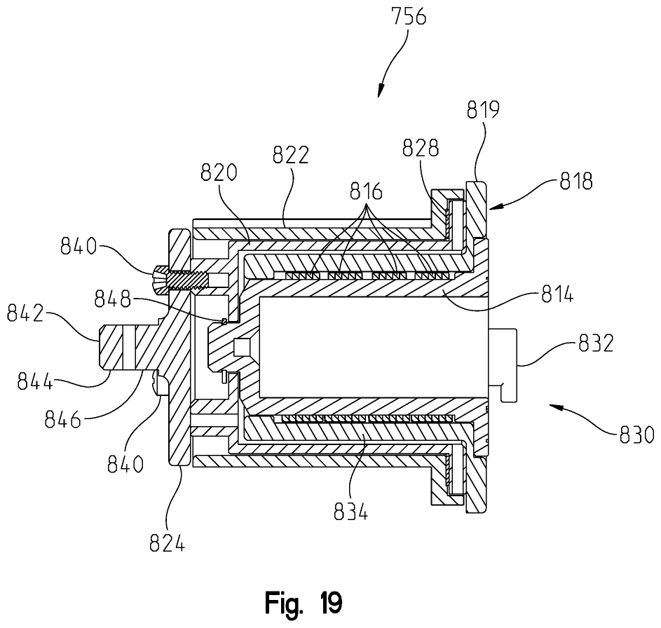

As illustrated in FIG. 19, one feature of the illustrated embodiment is the compact nature of the components. For example, preassembled torque adjustment input 756 positions lock 816 radially inward of an inner surface of roller tube 752. Lock 816 also located axially between a first end of roller tube 752 and a second end opposing the first end of roller tube 752.

Returning now to FIGS. 18-20, and with continuing reference to FIGS. 13-15, preassembled torque adjustment unit 756 also includes a fastener 848 which is used to discourage axial movement of output 820 relative to base 814, but otherwise permit relative rotation between the two. The fastener is a clip in the illustrated embodiment, sized to fit in a slot formed in an end of base 814. In embodiments, output 820 may be fastened to base 814 using other techniques, such as orbital riveting the end of base 814 to plastically deform material radially outward and thereby discourage axial displacement and removal of output 820 from base 814. A stamping operation may also be used to plastically deform the end of base 814 and thereby fasten output 820 to base 814.

An advantage, among others, of preassembled torque adjustment unit 756 is that it can be handled as an integrated unit in inventory, assembly, and/or repair operations. Given the nature of integration by which the component parts of preassembled torque adjustment units 756 are secured to each other as described herein, preassembled torque adjustment unit 756 may be pre-packaged and ready for integration into roller tube 752, reducing the number of parts required at that stage of assembly. Preassembled torque adjustment unit 756 may also be readily handled as a single integrated unit. For example, preassembled torque adjustment unit 756 may have a stock keeping unit (SKU) assigned to it and placed on a shelf, in a bin, etc., ready for use in assembly and/or repair. Faster repairs are also possible given the reduced complexity permitted by the integrated unit. The integrated and modular construction of preassembled torque adjustment unit 756 thus permits ease of assembly for manufacturing, ease of inventory management, and ease of replacement when repairs are needed for any given roller tube assembly 750.

In embodiments, a method of building roller tube assembly 750 is provided, wherein a torque generator includes at least one torque generator cassette 758 structured to provide a torque output, wherein a torque adjustment input and a first mount are part of a preassembled torque adjustment unit 756. The method comprising the steps of: assessing a minimum torque threshold required to counterbalance a torque imparted to roller tube 752 when a covering of roller tube 752 is extended in a downward position; identifying a number of torque generator cassettes 758 that provide a total torque output when operating together to exceed the minimum torque threshold; and operatively coupling the number of torque generator cassettes 758 to the preassembled torque adjustment unit 756. The method may further include wherein the number of torque generator cassettes 758 is a plurality of torque generator cassettes 758, and further comprising coupling a first pilot feature 810 of a first one of the plurality torque generator cassettes 758 to a second pilot feature 812 of a second one of the plurality of torque generator cassettes 758. The method may further include coupling a first pilot surface of the second one of the plurality torque generator cassettes to a coupling surface of the preassembled torque adjustment unit 756. The method may still further include placing the number of torque generator cassettes 758 and preassembled torque adjustment unit 754 into an interior of the roller tube 752. The method may further include suspending the roller tube assembly from brackets and adjusting the torque of the number of torque generator cassettes 758 through an adjustment of preassembled torque adjustment unit 754.

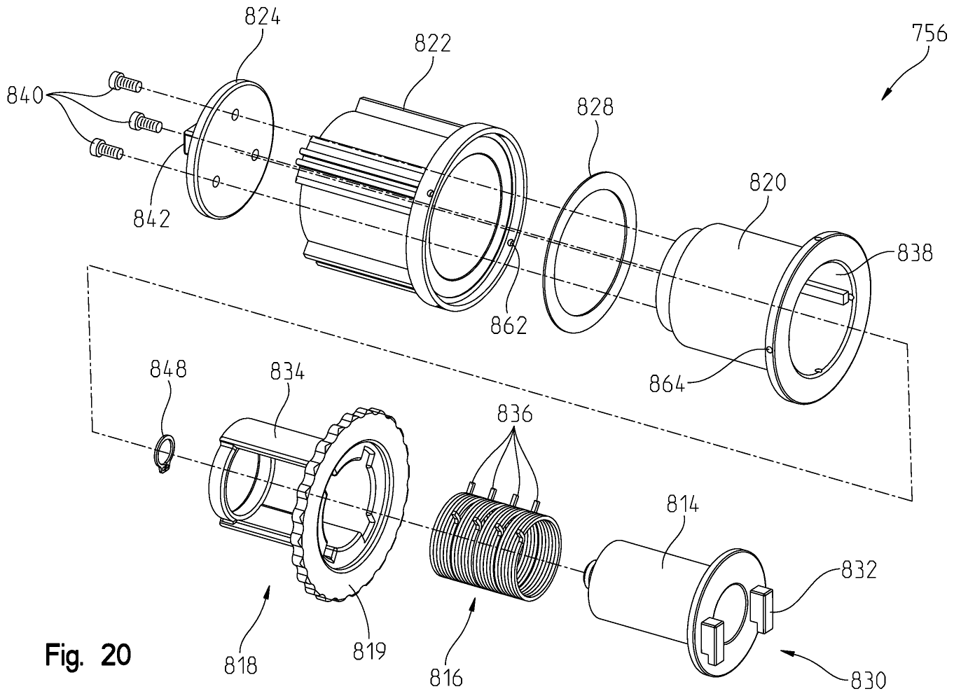

Once a desired torque setting of roller tube assembly 750 is set, in embodiments, a pin 860 (see FIG. 18) may be received in an opening 862 of roller tube interface 822 (see FIG. 20) and a corresponding opening 864 of output 820 (see FIG. 20) to hold the relative position of roller tube interface 822 to output 820.

While embodiments have been described as having exemplary designs, the present disclosure may be further modified within the spirit and scope of this disclosure. This application is therefore intended to cover any variations, uses, or adaptations of the disclosure using its general principles. Further, this application is intended to cover at least such departures from the present disclosure as come within known or customary practice in the art to which this disclosure pertains and which fall within the limits of the appended claims.

What is claimed is:

1. A roller tube assembly for supporting a window covering between a first window covering bracket and a second window covering bracket, the roller tube assembly comprising:
a roller tube adapted to have the window covering rolled onto to raise the window covering and rolled off of to lower the window covering;
a torque generator coupled to the roller tube and including a plurality of biasing members positioned within the roller tube;
a torque adjustment input operatively coupled to the torque generator and including an operator actuatable input engageable from outside of an envelope of the roller tube;
a first mount supporting a first end of the roller tube and adapted to be removably coupled to the first window covering bracket; and
a second mount supporting a second end of the roller tube and adapted to be removably coupled to the second window covering bracket, wherein the roller tube, the torque generator, the torque adjustment input, the first mount, and the second mount are a preassembled unit that is adapted to be coupled to the first window covering bracket and the second window covering bracket, and wherein the torque generator includes a plurality of torque generator cassettes coupled together, each torque generator cassette of the plurality of torque generator cassettes includes a biasing member of the plurality of biasing members, each torque generator cassette adapted to be operatively coupled to the torque adjustment input.

2. The roller tube assembly of claim 1, wherein the plurality of biasing members are in the form of a plurality of clock springs, wherein each torque generator cassette of the plurality of torque generator cassettes includes a housing, a shaft rotatable relative to the housing, a roller tube interface radially outward of the shaft to engage the roller tube, and a clock spring of the plurality of clock springs, the clock spring having a spiral configuration and including a first spring end operatively coupled to the shaft and a second spring end operatively coupled to the housing.

3. The roller tube assembly of claim 2, wherein each torque generator cassette of the plurality of torque generator cassettes further comprises a cover, the housing and the cover cooperating to define an interior space in which the clock spring is maintained.

4. The roller tube assembly of claim 3, wherein the shaft is captured between an end of the housing and the cover such that the shaft is axially constrained relative to the housing and the cover, and wherein the shaft is rotatable relative to the cover.

5. The roller tube assembly of claim 2, wherein the shaft is a shaft segment having a first shaft segment end and a second shaft segment end, wherein the first shaft segment end of each torque generator cassette includes a coupling interface that is structured to be coupled to a coupling interface of the second shaft segment end of each torque generator cassette.

6. The roller tube assembly of claim 5, wherein the coupling interface of each first shaft segment end includes a first pilot feature, wherein the coupling interface of each second shaft segment end includes a second pilot feature, wherein the first pilot feature is complementary to the second pilot feature, and wherein the first end is operatively coupled to the second end through mechanical engagement of the first pilot feature and the second pilot feature.

7. The roller tube assembly of claim 4, further comprising a fastener positioned to lock the shaft segment of a first torque generator cassette of the plurality of torque generator cassettes to the shaft segment of a second torque generator cassette of the plurality of torque generator cassettes such that relative axial movement between the first torque generator cassette and second torque generator cassette is discouraged.

8. The roller tube assembly of claim 1, wherein each torque generator cassette of the plurality of torque generator cassettes includes a housing, a cover, a shaft rotatable relative to the housing and cover, a roller tube interface radially outward of the shaft to engage the roller tube, and a biasing member of the plurality of biasing members, wherein the biasing member includes a first end operatively coupled to the shaft, and wherein the biasing member includes a second end having a portion that extends beyond a radially outer surface of the pack interface.

9. The roller tube assembly of claim 1, wherein the torque adjustment input and the first mount are part of a preassembled torque adjustment unit that is adapted to be operatively coupled to the plurality of torque generator cassettes.

10. The roller tube assembly of claim 9, wherein the preassembled torque adjustment unit includes a base including the first mount, an adjuster including the operator actuatable input rotatable relative to the base, an output operatively coupled to the plurality of torque generator cassettes and rotatable relative to the base; and a lock movable by the adjuster between an unlocked position wherein the output is rotatable relative to the base and a locked position wherein the output is held relative to the base.

11. The roller tube assembly of claim 10, wherein the output has an open interior into which is received each of the base, the lock, and the adjuster.

12. The roller tube assembly of claim 11, wherein the output includes an end in proximity to an end of the adjuster, wherein the adjuster moves relative to the output in a first mode of operation of the torque adjustment, and wherein the adjuster moves with the output in a second mode of operation of the torque adjustment.

13. The roller tube assembly of claim 11, wherein the lock is located radially inward of the roller tube between a first axial end of the roller tube and a second axial end of the roller tube.

14. The roller tube assembly of claim 10, wherein the preassembled torque adjustment unit further comprises a close out coupler mechanically coupled with the output, the closeout coupler operatively coupled to rotate with the output relative to the base when the adjuster positions the lock in the unlocked position.

15. The roller tube assembly of claim 14, wherein the preassembled torque adjustment unit further comprises a roller tube interface extending axially between the operator actuatable input of the adjuster and the closeout coupler, wherein an interior space of the roller tube interface receives the output, the lock, the adjuster, and the base, the roller tube interface being rotatable relative to the output when the lock is in either the locked position and the unlocked position.

16. A torque generator assembly for providing torque to a roller tube of a roller tube assembly as the roller tube assembly is operated between a first position and a second position, the torque generator assembly comprising:
an outer shell defined about a central axis and having an open interior;
an input interface accessible from a first axial exterior side of the outer shell;
an output interface accessible from a second axial exterior side of the outer shell and rotatable with the input interface, the output interface being sized and shaped to mate with the input interface; and
a biasing member disposed in the open interior of the outer shell, the biasing member including a first biasing end operatively coupled to input interface and a second biasing end operatively coupled to the outer shell to rotate about the central axis with the outer shell.

17. The spring assembly of claim 16, further comprising a shaft having a first shaft end and a second shaft end, wherein the first shaft end defines the input interface and the second shaft end defines the output interface.

18. The spring pack assembly of claim 17, wherein the first biasing end is operatively coupled with the shaft with a mechanical fastener.

19. The spring assembly of claim 17, wherein the outer shell is defined by a first axial end and a second axial end, the first axial end and the second axial end each limiting axial displacement of the shaft.

20. The spring assembly of claim 19, wherein the first axial end is defined by a cover and the second axial end is defined by a housing, wherein the shaft includes a first shaft shoulder and a second shaft shoulder, wherein the first shaft shoulder is configured to engage the cover and the second shaft shoulder is configured to engage the housing.

21. The spring assembly of claim 20, wherein the cover defines a first abutment surface configured to engage the first shaft shoulder of the shaft, wherein the housing defines a second abutment surface configured to engage the second shaft shoulder of the shaft, and wherein the shaft is operatively configured to rotate relative to the cover at the first abutment surface and the housing at second abutment surface, respectively.

22. The spring assembly of claim 17, wherein the first shaft end includes a plug defining a first pilot feature and the second shaft end includes a socket defining a second pilot feature, the socket of the second shaft end complementary to the plug of the first shaft end.

23. A method of building the roller tube assembly of claim 1, wherein the torque generator includes at least one torque generator cassette structured to provide a torque output, wherein the torque adjustment input and the first mount are part of a preassembled torque adjustment unit, and comprising the steps of:
assessing a minimum torque threshold required to counterbalance a torque imparted to the roller tube when a covering of the roller tube is extended in a downward position;
identifying a number of torque generator cassettes that provide a total torque output when operating together to exceed the minimum torque threshold; and
operatively coupling the number of torque generator cassettes to the preassembled torque adjustment unit.

24. The method of claim 23, wherein the number of torque generator cassettes is a plurality of torque generator cassettes, and further comprising coupling a first pilot feature of a first one of the plurality torque generator cassettes to a second pilot feature of a second one of the plurality of torque generator cassettes.

25. The method of claim 24, further comprising coupling a first pilot feature of the second one of the plurality torque generator cassettes to a coupling surface of the preassembled torque adjustment unit.

26. The method of claim 25, further comprising placing the number of torque generator cassettes and the preassembled torque adjustment unit into an interior of the roller tube.
